(19) United States
(12) Patent Application Publication
(10) Pub. No.: US 2025/0062437 A1
(43) Pub. Date: Feb. 20, 2025

(54) METHOD AND APPARATUS FOR CONTROLLING LIQUID-COOLED ENERGY STORAGE SYSTEM, ELECTRONIC DEVICE AND STORAGE MEDIUM

(71) Applicant: Shenzhen CLOU Electronics CO., LTD, Shenzhen (CN)

(72) Inventors: Dongfang LI, Shenzhen (CN); Jinzhi LIU, Shenzhen (CN)

(73) Assignee: Shenzhen CLOU Electronics CO., LTD, Shenzhen (CN)

(21) Appl. No.: 18/641,926

(22) Filed: Apr. 22, 2024

(30) Foreign Application Priority Data
Aug. 18, 2023 (CN) 202311050306.3

(51) Int. Cl. H01M 10/633; H01M 10/613; H01M 10/6568

(52) U.S. Cl. CPC H01M 10/633; H01M 10/613; H01M 10/6568

(57) ABSTRACT

A method and apparatus for controlling a liquid-cooled energy storage system are disclosed. A water inlet pressure and a water outlet pressure of a liquid-cooled unit are cyclically acquired, to calculate a difference therebetween in each cycle. A pressure difference change value in the current cycle is calculated according to the difference between the water inlet pressure and the water outlet pressure in a current cycle and the difference between the water inlet pressure and the water outlet pressure in a previous cycle. If the pressure difference change value is less than or equal to a first preset change value, a water pump duty cycle of a water pump is controlled according to corresponding preset temperature control policy, otherwise the water pump duty cycle of the water pump is controlled according to a preset liquid leakage detection policy.

### CROSS-REFERENCE TO RELATED APPLICATION

This U.S. application claims priority to Chinese patent application No. 202311050306.3 filed Aug. 18, 2023, the entire contents of which are incorporated herein by reference.

### TECHNICAL FIELD

The present disclosure relates to the technical field of liquid-cooled energy storage systems, in particular to a method and apparatus for controlling a liquid-cooled energy storage system, an electronic device, and a storage medium.

### BACKGROUND

The liquid-cooled energy storage system is widely applied in various scenarios, such as electrical vehicle, renewable energy, industrial energy storage and standby power supply, playing a crucial role in promoting sustainable development, reducing carbon emissions, and increasing the efficiency of energy utilization and the stability of power systems. The liquid-cooled energy storage system, which is an energy storage system utilizing liquid for thermal management, mainly relies on circulating liquid to absorb or release the heat generated by the energy storage system, so as to keep the temperature of the system within a safe range.

In the liquid-cooled energy storage system, the adjustment of a water pump duty cycle is very important to the performance of the system. By adjusting the water pump duty cycle, which dictates the operating time of the water pump, or the flow state of a coolant, the energy consumption and sealing integrity of the system can be influenced. In the related art, the water pump duty cycle is typically adjusted based on the requirement for system load. Due to the frequent load fluctuations, the water pump often has to operate in an unstable state, which often leads to the unreasonable setting of the water pump duty cycle, affecting the reliability of the system.

### SUMMARY

The present disclosure is intended to solve at least one of the technical problems in the existing technology. Therefore, embodiments of the present disclosure provide a method and apparatus for controlling a liquid-cooled energy storage system, an electronic device and a storage medium, which can increase the reliability of the liquid-cooled energy storage system.

In a first aspect, an embodiment of the present disclosure provides a method for controlling a liquid-cooled energy storage system, the liquid-cooled energy storage system comprising a liquid-cooled unit and a water pump, the method comprising:
cyclically acquiring a water inlet pressure and a water outlet pressure of the liquid-cooled unit;
obtaining a difference between the water inlet pressure and the water outlet pressure in each cycle according to the acquired water inlet pressure and the acquired water outlet pressure;
performing calculation according to the difference between the water inlet pressure and the water outlet pressure in a current cycle and the difference between the water inlet pressure and the water outlet pressure in a previous cycle to obtain a pressure difference change value in the current cycle; and
in the current cycle, if the pressure difference change value is less than or equal to a first preset change value, controlling a water pump duty cycle of the water pump according to a system temperature of the liquid-cooled energy storage system and a preset temperature control policy, otherwise controlling the water pump duty cycle of the water pump according to a preset liquid leakage detection policy.

In some embodiments of the present disclosure, the preset temperature control policy comprises a heating policy, a standby policy, a self-circulation policy, and a cooling policy; and the controlling a water pump duty cycle of the water pump according to a system temperature of the liquid-cooled energy storage system and a preset temperature control policy comprises:
controlling the liquid-cooled unit to adjust the water pump duty cycle of the water pump according to the heating policy if the system temperature is less than or equal to a first temperature threshold;
controlling the liquid-cooled unit to adjust the water pump duty cycle of the water pump according to the standby policy if the system temperature is greater than the first temperature threshold and less than or equal to a second temperature threshold;
controlling the liquid-cooled unit to adjust the water pump duty cycle of the water pump according to the self-circulation policy if the system temperature is greater than the second temperature threshold and less than or equal to a third temperature threshold; and
controlling the liquid-cooled unit to adjust the water pump duty cycle of the water pump according to the cooling policy if the system temperature is greater than the third temperature threshold.

In some embodiments of the present disclosure, the liquid-cooled energy storage system further comprises a plurality of liquid-cooled battery modules, wherein each of the liquid-cooled battery modules comprises a plurality of cells; and before the controlling a water pump duty cycle of the water pump according to a system temperature of the liquid-cooled energy storage system and a preset temperature control policy, the method further comprises:
acquiring a cell temperature of each of the cells;
for each of the liquid-cooled battery modules, taking a maximum one of the cell temperatures as a module temperature; and
taking a maximum one of the module temperatures as a system temperature.

In some embodiments of the present disclosure, the first temperature threshold is a first temperature, and the controlling the liquid-cooled unit to adjust the water pump duty cycle of the water pump according to the heating policy if the system temperature is less than or equal to a first temperature threshold comprises:
adjusting the water pump duty cycle of the water pump to a first duty cycle when the system temperature is greater than a second temperature and less than or equal to the first temperature;
adjusting the water pump duty cycle of the water pump to a second duty cycle when the system temperature is greater than a third temperature and less than or equal to the second temperature;
adjusting the water pump duty cycle of the water pump to a third duty cycle when the system temperature is greater than a fourth temperature and less than or equal to the third temperature;
adjusting the water pump duty cycle of the water pump to a fourth duty cycle when the system temperature is greater than a fifth temperature and less than or equal to the fourth temperature; and
adjusting the water pump duty cycle of the water pump to a fifth duty cycle when the system temperature is less than or equal to the fifth temperature;
wherein the first duty cycle, the second duty cycle, the third duty cycle, the fourth duty cycle and the fifth duty cycle increase in sequence.

In some embodiments of the present disclosure, the first temperature threshold is a first temperature, and the second temperature threshold is a sixth temperature; and the controlling the liquid-cooled unit to adjust the water pump duty cycle of the water pump according to the standby policy if the system temperature is greater than the first temperature threshold and less than or equal to a second temperature threshold comprises:
when the system temperature is greater than the first temperature and less than or equal to the sixth temperature, controlling the liquid-cooled unit to enter a standby mode, and keeping the water pump duty cycle of the water pump at a sixth duty cycle.

In some embodiments of the present disclosure, the second temperature threshold is a sixth temperature, and the third temperature threshold is a ninth temperature; and the controlling the liquid-cooled unit to adjust the water pump duty cycle of the water pump according to the self-circulation policy if the system temperature is greater than the second temperature threshold and less than or equal to a third temperature threshold comprises:
adjusting the water pump duty cycle of the water pump to a seventh duty cycle when the system temperature is greater than the sixth temperature and less than or equal to a seventh temperature;
adjusting the water pump duty cycle of the water pump to an eighth duty cycle when the system temperature is greater than the seventh temperature and less than or equal to an eighth temperature; and
adjusting the water pump duty cycle of the water pump to a ninth duty cycle when the system temperature is greater than the eighth temperature and less than or equal to the ninth temperature;
wherein the seventh duty cycle, the eighth duty cycle and the ninth duty cycle increase in sequence.

In some embodiments of the present disclosure, the third temperature threshold is a ninth temperature; and the controlling the liquid-cooled unit to adjust the water pump duty cycle of the water pump according to the cooling policy if the system temperature is greater than the third temperature threshold comprises:
adjusting the water pump duty cycle of the water pump to a tenth duty cycle when the system temperature is greater than the ninth temperature and less than or equal to a tenth temperature;
adjusting the water pump duty cycle of the water pump to an eleventh duty cycle when the system temperature is greater than the tenth temperature and less than or equal to an eleventh temperature;
adjusting the water pump duty cycle of the water pump to a twelfth duty cycle when the system temperature is greater than the eleventh temperature and less than or equal to a twelfth temperature;
adjusting the water pump duty cycle of the water pump to a thirteenth duty cycle when the system temperature is greater than the twelfth temperature and less than or equal to a thirteenth temperature; and
adjusting the water pump duty cycle of the water pump to a fourteenth duty cycle when the system temperature is greater than the thirteenth temperature;
wherein the tenth duty cycle, the eleventh duty cycle, the twelfth duty cycle, the thirteenth duty cycle and the fourteenth duty cycle increase in sequence.

In some embodiments of the present disclosure, the controlling the water pump duty cycle of the water pump according to a preset liquid leakage detection policy comprises:
generating a liquid leakage early-warning if the pressure difference change value is greater than the first preset change value;
when the pressure difference change value is greater than the first preset change value and less than or equal to a second preset change value, adjusting the water pump duty cycle of the water pump to 100%, and if the pressure difference change value is less than or equal to the second preset change value after a preset time, canceling the liquid leakage early-warning; and
when the pressure difference change value is greater than the second preset change value, adjusting the water pump duty cycle of the water pump to 0, and stopping operation of the liquid-cooled energy storage system.

In a second aspect, an embodiment of the present disclosure further provides an apparatus for controlling a liquid-cooled energy storage system, applying the method for controlling a liquid-cooled energy storage system according to the embodiment in the first aspect of the present disclosure, comprising:
an acquisition module, configured to cyclically acquire a water inlet pressure and a water outlet pressure of the liquid-cooled unit;
a first calculation module, configured to obtain a difference between the water inlet pressure and the water outlet pressure in each cycle according to the acquired water inlet pressure and the acquired water outlet pressure;
a second calculation module, configured to perform calculation according to the difference between the water inlet pressure and the water outlet pressure in a current cycle and the difference between the water inlet pressure and the water outlet pressure in a previous cycle to obtain a pressure difference change value in the current cycle; and
a control module, configured to, in the current cycle, if the pressure difference change value meets a first preset change value, control a water pump duty cycle of the water pump according to a system temperature of the liquid-cooled energy storage system and a preset temperature control policy, otherwise control the water pump duty cycle of the water pump according to a preset liquid leakage detection policy.

In a third aspect, an embodiment of the present disclosure further provides an electronic device, comprising a memory and a processor, wherein the memory stores a computer program, and the processor, when executing the computer program, implements the method for controlling a liquid-cooled energy storage system according to the embodiment in the first aspect of the present disclosure.

In a fourth aspect, an embodiment of the present disclosure further provides a computer-readable storage medium storing a program, wherein the program, when executed by a processor, causes the processor to implement the method for controlling a liquid-cooled energy storage system according to the embodiment in the first aspect of the present disclosure.

The embodiments of the present disclosure at least include the following beneficial effects:

The embodiments of the present disclosure provide a method and apparatus for controlling a liquid-cooled energy storage system, an electronic device and a storage medium, wherein the liquid-cooled energy storage system comprises a liquid-cooled unit and a water pump. In the method, a water inlet pressure and a water outlet pressure of the liquid-cooled unit are acquired cyclically, and a corresponding difference between the water inlet pressure and the water outlet pressure in each cycle is obtained according to the acquired water inlet pressure and the acquired water outlet pressure. Calculation is performed according to the difference between the water inlet pressure and the water outlet pressure in a current cycle and the difference between the water inlet pressure and the water outlet pressure in a previous cycle to obtain a pressure difference change value in the current cycle. If the pressure difference change value is less than or equal to a first preset change value, a water pump duty cycle of the water pump is controlled according to a system temperature of the liquid-cooled energy storage system and the preset temperature control policy, otherwise the water pump duty cycle of the water pump is controlled according to a preset liquid leakage detection policy. Therefore, the pressure difference change value is monitored and calculated in real time by utilizing the difference between the water inlet pressure and the water outlet pressure of the liquid-cooled unit, and the different preset policies are chosen to control the water pump duty cycle according to the pressure difference change value. If the pressure difference change value is less than or equal to the first preset change value, it is determined that the sealing integrity of the system is good at this moment, so the energy saving of the system is emphasized. A too high water pump duty cycle will increase the power consumption and temperature of the water pump, while a too low water pump duty cycle will decrease the cooling effect, leading to an increase in the system temperature. Therefore, considering the influence of temperature, a reasonable duty cycle is generated according to the preset temperature control policy in order to meet the requirement of energy saving and increase the reliability of the system. In addition, if the pressure difference change value is greater than the first preset change value, it means that the system is unstable at this moment, and there may be a risk of liquid leakage. At this moment, the sealing integrity of the system is at high priority. Therefore, it is necessary to control the water pump duty cycle for liquid leakage detection according to the preset liquid leakage detection policy to strike a balance between the pressure and sealing integrity of the system, so as to ensure the normal operation of the system, accurately detect in time whether liquid leakage occurs, and increase the reliability of the system.

The additional aspects and advantages of the present disclosure will be partially set forth in the following description, and will partially become apparent from the following description or be understood through the practice of the present disclosure.

### BRIEF DESCRIPTION OF DRAWINGS

The aforementioned and/or additional aspects and advantages of the present disclosure will become apparent and easily understood from the description of embodiments in reference to the following drawings, in which:

FIG. 1 is a schematic flowchart of a method for controlling a liquid-cooled energy storage system according to an embodiment of the present disclosure;

FIG. 2 is a schematic flowchart of Step S104 in FIG. 1;

FIG. 3 is a schematic diagram of a liquid-cooled container according to an embodiment of the present disclosure;

FIG. 4 is a schematic flowchart before Step S104 in FIG. 1;

FIG. 5 is a schematic flowchart of Step S201 in FIG. 2;

FIG. 6 is a schematic flowchart of Step S203 in FIG. 2;

FIG. 7 is a schematic flowchart of Step S204 in FIG. 2;

FIG. 8 is a variation curve of water pump duty cycle according to an embodiment of the present disclosure;

FIG. 9 is another schematic flowchart of Step S104 in FIG. 1;

FIG. 10 is a flowchart of a method for controlling a liquid-cooled energy storage system according to an embodiment of the present disclosure;

FIG. 11 is a flowchart of a preset leakage detection policy according to an embodiment of the present disclosure;

FIG. 12 is a flowchart of a preset temperature control policy according to an embodiment of the present disclosure;

FIG. 13 is a schematic module diagram of an apparatus for controlling a liquid-cooled energy storage system according to an embodiment of the present disclosure; and

FIG. 14 is a schematic structural diagram of an electronic device according to an embodiment of the present disclosure.

Reference numerals: acquisition module 100; first calculation module 200; second calculation module 300; control module 400; electronic device 1000; processor 1001; memory 1002.

### DETAILED DESCRIPTION

In order to make the objective, technical solution and advantages of the present disclosure clearer, the present disclosure will be further described in detail below with reference to the accompanying drawings and embodiments. It should be understood that the specific embodiments described herein are merely intended to explain the present disclosure rather than limit the present disclosure.

The embodiments of the present disclosure will be described in detail below, and the examples of the embodiments are shown in the accompanying drawings, throughout which identical or similar reference numerals represent identical or similar elements or elements having identical or similar functions. The embodiments described below with reference to the accompanying drawings are exemplary and are merely intended to explain the present disclosure rather than be construed as limiting the present disclosure.

In the description of the present disclosure, it should be understood that direction descriptions involved, e.g. directions and positional relationships indicated by “upper”, “lower”, “front”, “back”, “left”, “right” and the like, are based on the directions or positional relationships shown in the accompanying drawings, and are merely intended to facilitate and simplify the description of the present disclosure rather than indicate or imply that the indicated device or elements must have specific directions, be configured and operated according to the specific directions, and therefore cannot be understood as a limitation to the present disclosure.

In the description of the present disclosure, “several” means one or more, while “a plurality of” means two or more. “Greater than”, “less than”, “exceed” and the like should be understood as excluding the following number, while “more than”, “less than”, “within” and the like should be understood as including the following number. If described, “first” and “second” are merely intended to distinguish technical features rather than understood as indicating or implying relative importance or implicitly indicating the number of indicated technical features or implicitly indicating the precedence relationship of the indicated technical features.

In the description of the present disclosure, unless explicitly defined otherwise, the words such as “arrange”, “mount” and “connect” should be understood in a broad sense, and those of ordinary skills in the art can reasonably determine the specific meanings of the aforementioned words in the present disclosure in conjunction with the specific contents of the technical solution.

The liquid-cooled energy storage system is widely applied in various scenarios, such as electrical vehicle, renewable energy, industrial energy storage and standby power supply, playing a crucial role in promoting sustainable development, reducing carbon emissions, and increasing the efficiency of energy utilization and the stability of power systems. The liquid-cooled energy storage system, which is an energy storage system utilizing liquid for thermal management, mainly relies on circulating liquid to absorb or release the heat generated by the energy storage system, so as to keep the temperature of the system within a safe range.

In the liquid-cooled energy storage system, the adjustment of a water pump duty cycle is very important to the performance of the system. By adjusting the water pump duty cycle, which dictates the operating time of the water pump, or the flow state of a coolant, the energy consumption and sealing integrity of the system can be influenced. In the related art, the water pump duty cycle is typically adjusted based on the requirement for system load. Due to the frequent load fluctuations, the water pump often has to operate in an unstable state, which often leads to the unreasonable setting of the water pump duty cycle, affecting the reliability of the system. Moreover, the operating mode of the liquid-cooled unit cannot accurately control the cell temperature of the system. For example, the liquid-cooled unit will still be cooling cells even if the temperature of the cells is too low, further increasing the system temperature difference, resulting in great auxiliary power consumption.

In view of this, embodiments of the present disclosure provide a method and apparatus for controlling a liquid-cooled energy storage system, an electronic device and a storage medium. The liquid-cooled energy storage system includes a liquid-cooled unit and a water pump. In the method, a water inlet pressure and a water outlet pressure of the liquid-cooled unit are acquired cyclically, and a corresponding difference between the water inlet pressure and the water outlet pressure in each cycle is obtained according to the acquired water inlet pressure and the acquired water outlet pressure. The difference between the water inlet pressure and the water outlet pressure in the current cycle and the difference between the water inlet pressure and the water outlet pressure in the previous cycle are calculated to obtain a pressure difference change value in the current cycle, and if the pressure difference change value is less than or equal to a first preset change value, a water pump duty cycle of the water pump is controlled according to a system temperature of the liquid-cooled energy storage system and a preset temperature control policy, otherwise the water pump duty cycle of the water pump is controlled according to a preset liquid leakage detection policy. Therefore, the pressure difference change value is monitored in real time by utilizing the difference between the water inlet pressure and the water outlet pressure of the liquid-cooled unit, and the different preset policies are chosen to control the water pump duty cycle according to the pressure difference change value. If the pressure difference change value is less than or equal to the first preset change value, it is determined that the sealing integrity of the system is relatively good, so the energy saving of the system is emphasized. Because a too high water pump duty cycle will increase the power consumption and temperature of the pump, a too low water pump duty cycle will decrease the cooling effect, leading to an increase in the system temperature. Therefore, considering the influence of temperature, a reasonable duty cycle is generated according to the preset temperature control policy in order to meet the requirement of energy saving and increase the reliability of the system. In addition, if the pressure difference change value is greater than the first preset change value, it means that the system is unstable, and there may be a risk of liquid leakage. At this moment, the sealing integrity of the system is at high priority. Therefore, it is necessary to control the water pump duty cycle for liquid leakage detection according to the preset liquid leakage detection policy to strike a balance between the pressure and sealing integrity of the system, so as to ensure the normal operation of the system, accurately detect in time whether liquid leakage occurs, and increase the reliability of the system.

The method for controlling a liquid-cooled energy storage system in the embodiments of the present disclosure will be described below.

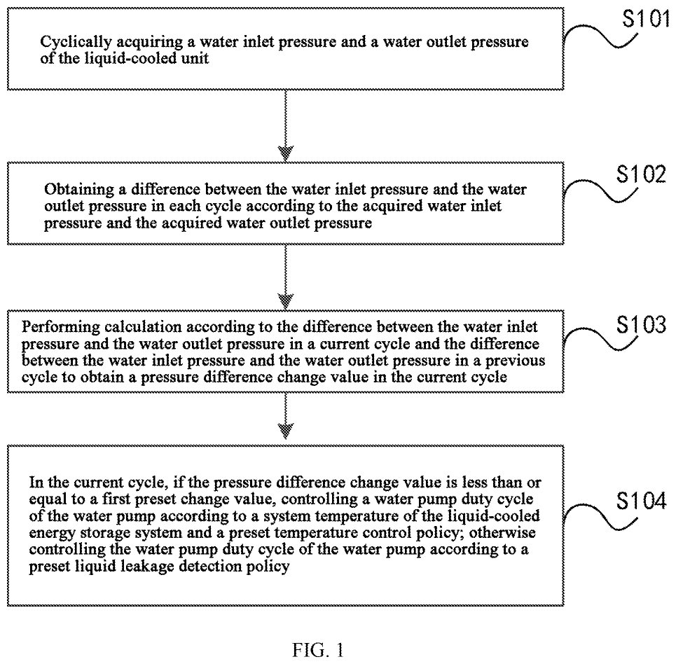

Referring to FIG. 1, an embodiment of the present disclosure provides a method for controlling a liquid-cooled energy storage system. The liquid-cooled energy storage system includes a liquid-cooled unit and a water pump. The method includes, but is not limited to, Step S101 to Step S104 below.

At Step S101, a water inlet pressure and a water outlet pressure of the liquid-cooled unit are cyclically acquired.

It can be understood that the liquid-cooled unit is a core device in the liquid-cooled energy storage system, which relies on circulating liquid to absorb or release the heat generated by the energy storage system, so as to keep the temperature of the system within a safe range. The water pump is used to drive the circulating flow of the liquid in the system, which typically uses a centrifugal pump or a positive displacement pump with efficient and stable operating characteristics. By providing enough pressure and flow, the water pump pumps the liquid out of the water outlet of the liquid-cooled unit and conveys it back to the water inlet of the liquid-cooled unit, so as to implement the circulating flow of the liquid.

In some embodiments, the water inlet pressure and the water outlet pressure of the liquid-cooled unit may be acquired cyclically at a preset time interval. The water inlet and the water outlet of the liquid-cooled unit typically need a certain water inlet pressure and a certain water outlet pressure to ensure that the liquid can smoothly enter the liquid-cooled unit and circulate and, at the same time, ensure that the liquid can smoothly flow out and back to the system. For example, with 5 seconds as a cycle, the water inlet pressure and the water outlet pressure of the liquid-cooled unit are acquired every 5 seconds, or with 5 minutes as a cycle, the water inlet pressure and the water outlet pressure of the liquid-cooled unit are acquired every 5 minutes. Those of ordinary skills in the art can set the cycle according to actual requirements, which is not limited in the embodiments of the present disclosure.

At Step S102, a difference between the water inlet pressure and the water outlet pressure in each cycle is obtained according to the acquired water inlet pressure and the acquired water outlet pressure.

It can be understood that the difference between the water inlet pressure and the water outlet pressure refers to a pressure difference between the water inlet and the water outlet of the liquid-cooled unit, and plays an important role in the normal operation of the liquid-cooled unit and the circulation of the liquid. Firstly, an appropriate difference between the water inlet pressure and the water outlet pressure can ensure the circulation of the liquid in the liquid-cooled system. The pressure difference drives the liquid to flow into the liquid-cooled unit from the water inlet, pass through a radiator or other cooling apparatuses, and then flow out from the water outlet, forming circulation. If the difference between the water inlet pressure and the water outlet pressure is insufficient, the liquid may not flow smoothly, resulting in a poor cooling effect or failure to implement cooling. Secondly, an appropriate difference between the water inlet pressure and the water outlet pressure can prevent the liquid from flowing reversely. If the pressure at the water outlet is lower than that at the water inlet, the liquid may flow reversely, which will decrease the cooling effect of the system and may cause other problems such as liquid leakage or bubble formation. Therefore, an appropriate difference between the water inlet pressure and the water outlet pressure can ensure the circulation of the liquid, increase the efficiency of heat transfer, prevent the liquid from flowing reversely and protect the normal operation of the liquid-cooled unit. Therefore, it is important to monitor and calculate the difference between the water inlet pressure and the water outlet pressure of the liquid-cooled unit in real time.

In some embodiments, calculation is performed according to the acquired water inlet pressure and the acquired water outlet pressure, so as to obtain a difference between the water inlet pressure and the water outlet pressure in each cycle. For example, if the water inlet pressure and the water outlet pressure of the liquid-cooled unit acquired in a certain cycle are Pᵢₙ and Pₒᵤₜ, then the calculated difference between the water inlet pressure and the water outlet pressure is ΔP=Pₒᵤₜ−Pᵢₙ.

At Step S103, a pressure difference change value in the current cycle is calculated according to the difference between the water inlet pressure and the water outlet pressure in the current cycle and the difference between the water inlet pressure and the water outlet pressure in the previous cycle.

In some embodiments, the pressure difference change value is calculated from the difference between the water inlet pressure and the water outlet pressure in the current cycle and the difference between the water inlet pressure and the water outlet pressure in the previous cycle. For example, if the difference between the water inlet pressure and the water outlet pressure in the current cycle is ΔP1 and the difference between the water inlet pressure and the water outlet pressure in the previous cycle is ΔP2, then the corresponding pressure difference change value is calculated as K=ΔP1−ΔP2.

It can be understood that the stability of the pressure difference change value has an important influence on the reliability of the liquid-cooled energy storage system. A too large pressure difference change value may lead to the instability of the system and affect the circulation and cooling effect of the liquid. Moreover, a too large or too small pressure difference change value may lead to the unsmooth flow or reverse flow of the liquid in the system, increasing safety risks such as leakage, bubble formation, etc. Therefore, by cyclically monitoring and calculating the pressure difference change value in real time, related problems can be discovered and dealt with in time, so that the reliability and safety of the liquid-cooled energy storage system can be effectively improved.

At Step S104, in the current cycle, if the pressure difference change value is less than or equal to a first preset change value, a water pump duty cycle of the water pump is controlled according to a system temperature of the liquid-cooled energy storage system and a preset temperature control policy, otherwise the water pump duty cycle of the water pump is controlled according to a preset liquid leakage detection policy.

In some embodiments, if the pressure difference change value is less than or equal to the first preset change value, then it is considered that the pressure difference is stable, the liquid-cooled energy storage system has no risks such as liquid leakage, etc., and the water pump duty cycle of the water pump can be controlled according to the current system temperature of the liquid-cooled energy storage system and the preset temperature control policy. It can be understood that the water pump duty cycle refers to the ratio between the operating time and stopping time of the water pump. The water pump duty cycle is typically expressed in percentage. For example, a duty cycle of 50% means that the operating time of the water pump accounts for 50% of the total time. An appropriate water pump duty cycle can ensure the sufficient and uniform circulation of the cooling liquid. A too high duty cycle may lead to a too high flow rate of the cooling liquid, while a too low duty cycle may lead to insufficient circulation, affecting the cooling effect. Moreover, the operation of the water pump needs to consume a certain amount of energy, but energy can be saved at the stopping time. Therefore, by setting the preset policies to control the water pump duty cycle, the embodiments of the present disclosure can ensure the sufficient flow and heat transfer of the cooling liquid in the system, increasing the cooling effect, and reduce the energy consumption of the pipelines of the system on the premise of meeting the cooling requirement, increasing the efficiency of energy utilization.

In some embodiments, if the pressure difference change value is greater than the first preset change value, then it is considered that the pressure difference is unstable, and the liquid-cooled energy storage system has a risk of liquid leakage, so it is necessary to control the water pump duty cycle of the water pump according to the preset liquid leakage detection policy to further check the liquid leakage. Therefore, pipeline sealing integrity is monitored and calculated in real time by utilizing the difference between the water inlet pressure and the water outlet pressure of the liquid-cooled unit, and the water pump duty cycle is controlled according to the preset policies to realize the energy-saving and efficient operation of the liquid-cooled unit, effectively increasing the reliability and safety of the liquid-cooled energy storage system and reducing the auxiliary power consumption of the pipelines.

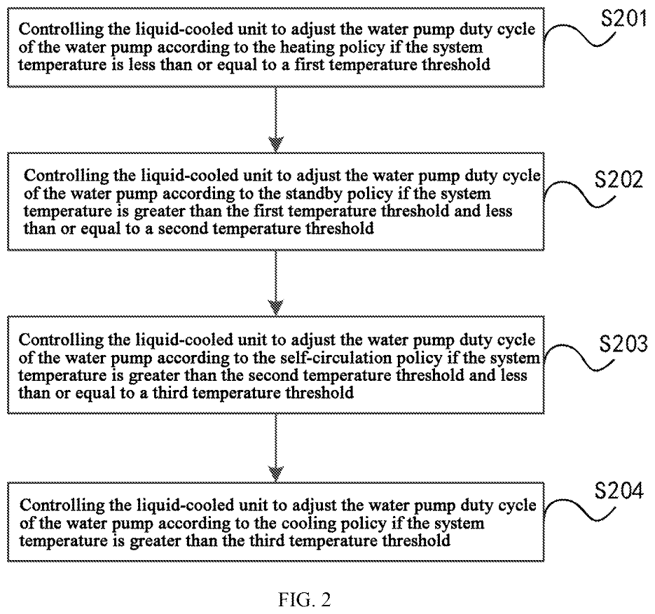

Referring to FIG. 2, in some embodiments of the present disclosure, the preset temperature control policy includes a heating policy, a standby policy, a self-circulation policy, and a cooling policy. Step S104 above may further include, but is not limited to, Step S201 to Step S204 below.

At Step S201, the liquid-cooled unit is controlled to adjust the water pump duty cycle of the water pump according to the heating policy if the system temperature is less than or equal to a first temperature threshold.

In some embodiments, a low-temperature environment may cause damage to the device in the liquid-cooled system, such as freeze-bursting and blockage of the pipelines. Through the heating policy to maintain an appropriate temperature, these problems can be effectively prevented, increasing the service life and reliability of the device. Therefore, when the system temperature is less than or equal to the first temperature threshold, the flow rate in the pipelines is increased to increase the amount of high-temperature fluid for heating. Specifically, heating is implemented by controlling the liquid-cooled unit to adjust the water pump duty cycle of the water pump according to the heating policy.

For example, if the first temperature threshold is set to 20° C., when the system temperature is less than or equal to 20° C., the liquid-cooled unit is controlled to adjust the water pump duty cycle of the water pump according to the heating policy. The first temperature threshold may also be set to 18° C. or 22° C., and can be set by those of ordinary skills in the art according to actual requirements, which is not limited in the embodiments of the present disclosure.

At Step S202, the liquid-cooled unit is controlled to adjust the water pump duty cycle of the water pump according to the standby policy if the system temperature is greater than the first temperature threshold and less than or equal to a second temperature threshold.

In some embodiments, if the current system temperature of the liquid-cooled energy storage system is greater than the first temperature threshold and less than or equal to the second temperature threshold, it is considered that the system temperature at this moment is appropriate, and the liquid-cooled unit is controlled to adjust the water pump duty cycle of the water pump according to the standby policy. It can be understood that the standby policy means that the liquid-cooled unit enters an energy-saving standby state when the energy storage system does not require cooling or liquid circulation. The main purpose of the standby policy is to reduce energy consumption and prevent unnecessary operation, and thus reduce power consumption and energy consumption.

For example, the first temperature threshold is set to 20° C. and the second temperature threshold is set to 25° C. When the system temperature is greater than 20° C. and less than or equal to 25° C., the liquid-cooled unit is controlled to adjust the water pump duty cycle of the water pump according to the standby policy. The first temperature threshold and the second temperature threshold may also be set to other values, which is not limited in the embodiments of the present disclosure.

At Step S203, the liquid-cooled unit is controlled to adjust the water pump duty cycle of the water pump according to the self-circulation policy if the system temperature is greater than the second temperature threshold and less than or equal to a third temperature threshold.

In some embodiments, the liquid-cooled unit is controlled to adjust the water pump duty cycle of the water pump according to the self-circulation policy if the current system temperature of the liquid-cooled energy storage system is greater than the second temperature threshold and less than or equal to the third temperature threshold. It can be understood that the self-circulation policy is that the liquid-cooled unit implements the circulation and cooling of the liquid through its own operation without external driving. Its main characteristic is that the liquid-cooled unit always keeps operating during the operation of the energy storage system and circulates the liquid for cooling, thus ensuring the stable operation of the system, and has the advantages of automatic operation, energy saving, environmental protection, system stability, etc.

For example, the second temperature threshold is set to 25° C. and the third temperature threshold is set to 28° C. When the system temperature is greater than 25° C. and less than or equal to 28° C., the liquid-cooled unit is controlled to adjust the water pump duty cycle of the water pump according to the self-circulation policy. The second temperature threshold and the third temperature threshold may also be set to other values, which is not limited in the embodiments of the present disclosure.

At Step S204, the liquid-cooled unit is controlled to adjust the water pump duty cycle of the water pump according to the cooling policy if the system temperature is greater than the third temperature threshold.

In some embodiments, similar to the low-temperature environment, if the liquid-cooled energy storage system is in a high-temperature environment for a long time, it will also cause damage to the device in the liquid-cooled system, leading to various safety risks. Therefore, through the cooling policy, an appropriate temperature can be maintained, thus increasing the service life and reliability of the device. Specifically, if the system temperature is greater than the third temperature threshold, the liquid-cooled unit is controlled to adjust the water pump duty cycle of the water pump according to the cooling policy to implement cooling.

For example, if the third temperature threshold is set to 28° C., when the system temperature is greater than 28° C., the liquid-cooled unit is controlled to adjust the water pump duty cycle of the water pump according to the cooling policy. The third temperature threshold may also be set to 29° C. or 30° C., and can be set by those of ordinary skills in the art according to actual requirements, which is not limited in the embodiments of the present disclosure.

Therefore, according to different system temperatures, the preset temperature control policy including the heating policy, the standby policy, the self-circulation policy and the cooling policy and water pump duty cycles corresponding to the different policies are formulated, realizing the energy-saving and efficient operation of the liquid-cooled unit and reducing the auxiliary power consumption of the pipelines.

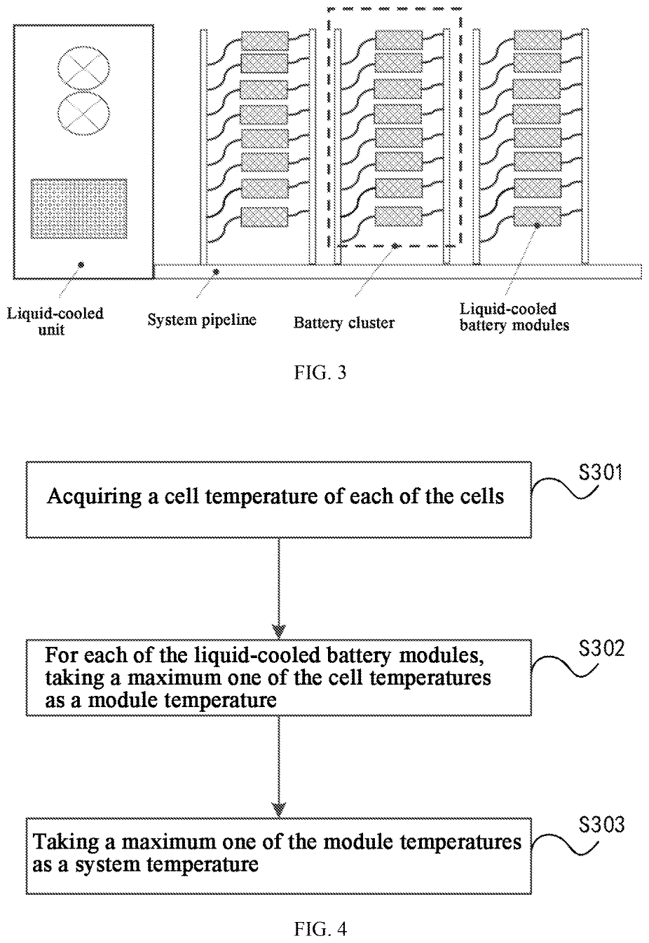

In some embodiments of the present disclosure, referring to the schematic diagram of the liquid-cooled container shown in FIG. 3, the liquid-cooled energy storage system further includes a plurality of battery clusters, each battery cluster includes a plurality of liquid-cooled battery modules, and each liquid-cooled battery module further includes a plurality of cells, which are energy storage units of the energy storage system. The cells in the liquid-cooled battery modules are cooled by liquid circulation, so as to keep the temperature of the cells stable and increase the service life and performance of the batteries. Referring to FIG. 4, before Step S104, the method may include, but is not limited to, Step S301 to Step S303 below.

At Step S301, a cell temperature of each of the cells is acquired.

In some embodiments, it is crucial to maintain a stable cell temperature for increasing the service life and performance of the batteries. Moreover, the cell temperature also significantly impacts the performance, safety and service life of the energy storage system. Therefore, the present disclosure needs to acquire the cell temperature of each cell in each liquid-cooled battery module before acquiring the system temperature.

At Step S302, for each of the liquid-cooled battery modules, the maximum one of the cell temperatures is taken as a module temperature.

In some embodiments, for each liquid-cooled battery module, the maximum one of the cell temperatures corresponding to the plurality of cells included in the liquid-cooled battery module is taken as a module temperature of the liquid-cooled battery module. For example, one liquid-cooled battery module includes seven cells, and assuming that the acquired seven cell temperatures are 18° C., 19° C., 23° C., 22° C., 17° C., 20° C. and 22° C. in sequence, the maximum one of the cell temperatures is 23° C., so the module temperature of the liquid-cooled battery module is 23° C.

At Step S303, the maximum one of the module temperatures is taken as a system temperature.

In some embodiments, after the maximum one of the cell temperatures of each liquid-cooled battery module is taken as the module temperature, a plurality of module temperatures can be obtained, and the maximum one of the module temperatures acquired from all the liquid-cooled battery modules in the liquid-cooled container is taken as the system temperature. Therefore, the system temperature corresponds to the highest temperature in the liquid-cooled container. In this way, using the cell temperature directly to control the preset temperature control policy of the liquid-cooled unit, i.e., to control the four preset temperature control policies including the heating policy, the standby policy, the self-circulation policy and the cooling policy, enables meeting the thermal management requirements of the system cells, thereby realizing more refined management and the accurate temperature control and energy-saving and efficient operation of the liquid-cooled unit.

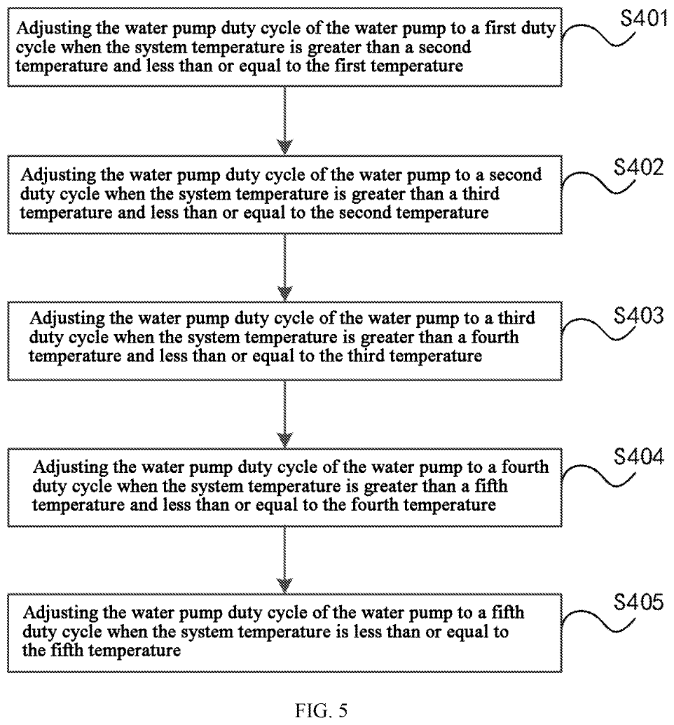

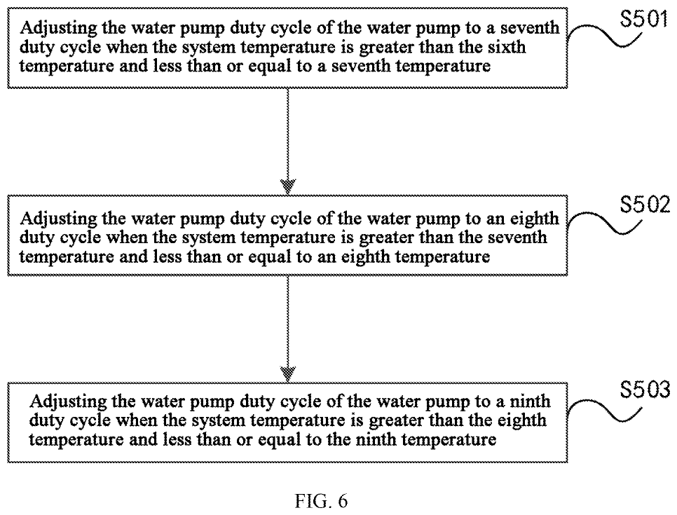

Referring to FIG. 5, in some embodiments of the present disclosure, Step S201 may further include, but is not limited to, Step S401 to Step S405 below.

At Step S401, the water pump duty cycle of the water pump is adjusted to a first duty cycle when the system temperature is greater than a second temperature and less than or equal to the first temperature.

In some embodiments, the first temperature threshold is the first temperature, and the water pump duty cycle of the water pump is adjusted to the first duty cycle when the system temperature is greater than the second temperature and less than or equal to the first temperature. For example, the first temperature is 20° C. and the second temperature is 19° C. When the system temperature is greater than 19° C. and less than or equal to 20° C., the water pump duty cycle of the water pump is adjusted to 20%, that is, the first duty cycle is 20% correspondingly. It can be understood that those of ordinary skills in the art can set specific values for the first temperature, the second temperature and the first duty cycle according to actual requirements, which is not limited in the embodiments of the present disclosure.

At Step S402, the water pump duty cycle of the water pump is adjusted to a second duty cycle when the system temperature is greater than a third temperature and less than or equal to the second temperature.

In some embodiments, the second temperature is 19° C. and the third temperature is 18° C. When the system temperature is greater than 18° C. and less than or equal to 19° C., the water pump duty cycle of the water pump is adjusted to 40%, that is, the second duty cycle is 40% correspondingly. The third temperature is lower than the second temperature, and correspondingly the second duty cycle is greater than the first duty cycle, thus achieving more efficient heating at lower temperature. It can be understood that those of ordinary skills in the art can set specific values for the second temperature, the third temperature and the second duty cycle according to actual requirements, which is not limited in the embodiments of the present disclosure.

At Step S403, the water pump duty cycle of the water pump is adjusted to a third duty cycle when the system temperature is greater than a fourth temperature and less than or equal to the third temperature.

In some embodiments, the third temperature is 18° C. and the fourth temperature is 17° C. When the system temperature is greater than 17° C. and less than or equal to 18° C., the water pump duty cycle of the water pump is adjusted to 60%, that is, the third duty cycle is 60% correspondingly. The fourth temperature is lower than the third temperature and the second temperature, and correspondingly the third duty cycle is greater than the first duty cycle and the second duty cycle, thus ensuring more efficient heating at lower temperature. It can be understood that those of ordinary skills in the art can set specific values for the third temperature, the fourth temperature and the third duty cycle according to actual requirements, which is not limited in the embodiments of the present disclosure.

At Step S404, the water pump duty cycle of the water pump is adjusted to a fourth duty cycle when the system temperature is greater than a fifth temperature and less than or equal to the fourth temperature.

In some embodiments, the fourth temperature is 17° C. and the fifth temperature is 16° C. When the system temperature is greater than 16° C. and less than or equal to 17° C., the water pump duty cycle of the water pump is adjusted to 80%, that is, the fourth duty cycle is 80% correspondingly. It can be understood that those of ordinary skills in the art can set specific values for the third temperature, the fourth temperature and the third duty cycle according to actual requirements, which is not limited in the embodiments of the present disclosure.

At Step S405, the water pump duty cycle of the water pump is adjusted to a fifth duty cycle when the system temperature is less than or equal to the fifth temperature.

In some embodiments, the fifth temperature is 16° C., and when the system temperature is less than or equal to 16° C., the water pump duty cycle of the water pump is adjusted to 100%, that is, the fifth duty cycle is 100% correspondingly. Therefore, in the low-temperature environment, the efficiency of heating the cells by the high-temperature fluid can be increased by increasing the flow rate in the pipelines. Specifically, the heating policy of the liquid-cooled unit is shown in Table 1 below, and the first duty cycle, the second duty cycle, the third duty cycle, the fourth duty cycle and the fifth duty cycle increase in sequence, thus achieving more efficient heating at lower temperature.

TABLE 1
Heating Policy

| System Temperature | Water Pump Duty Cycle |
|---|---|
| T ≤ 16° C. | 100% |
| 16° C. < T ≤ 17° C. | 80% |
| 17° C. < T ≤ 18° C. | 60% |
| 18° C. < T ≤ 19° C. | 40% |
| 19° C. < T ≤ 20° C. | 20% |

In some embodiments of the present disclosure, the second temperature threshold is a sixth temperature, and when the system temperature is greater than the first temperature and less than or equal to the sixth temperature, the liquid-cooled unit is controlled to enter a standby mode. At this moment, neither heating nor cooling is performed, and the water pump duty cycle of the water pump is kept at a sixth duty cycle. For example, the first temperature corresponding to the first temperature threshold is 20° C., and the sixth temperature corresponding to the second temperature threshold is 25° C. Therefore, when the system temperature is greater than 20° C. and less than or equal to 25° C., the water pump duty cycle of the water pump is kept at 20%, and the sixth duty cycle is 20% correspondingly. Specifically, the standby policy of the liquid-cooled unit is shown in Table 2 below.

TABLE 2
Standby Policy

| System Temperature T | Water Pump Duty Cycle |
|---|---|
| 20° C. < T ≤ 21° C. | 20% |
| 21° C. < T ≤ 22° C. | 20% |
| 22° C. < T ≤ 23° C. | 20% |
| 23° C. < T ≤ 24° C. | 20% |
| 24° C. < T ≤ 25° C. | 20% |

Referring to FIG. 6, in some embodiments of the present disclosure, Step S203 above may further include, but is not limited to, Step S501 to Step S503 below.

At Step S501, the water pump duty cycle of the water pump is adjusted to a seventh duty cycle when the system temperature is greater than the sixth temperature and less than or equal to a seventh temperature.

In some embodiments, the second temperature threshold is the sixth temperature, and the third temperature threshold is a ninth temperature. The water pump duty cycle of the water pump is adjusted to the seventh duty cycle when the system temperature is greater than the sixth temperature and less than the seventh temperature. For example, the sixth temperature is 25° C. and the seventh temperature is 26° C. When the system temperature is greater than 25° C. and less than 26° C., the water pump duty cycle of the water pump is adjusted to 20%, that is, the seventh duty cycle is 20% correspondingly, which is not limited in the embodiments of the present disclosure. At Step S502, the water pump duty cycle of the water pump is adjusted to an eighth duty cycle when the system temperature is greater than the seventh temperature and less than or equal to an eighth temperature.

In some embodiments, the seventh temperature is 26° C. and the eighth temperature is 27° C. When the system temperature is greater than 26° C. and less than 27° C., the water pump duty cycle of the water pump is adjusted to 50%, that is, the eighth duty cycle is 50% correspondingly. It can be understood that those of ordinary skills in the art can set specific values for the seventh temperature, the eighth temperature and the eighth duty cycle according to actual requirements, which is not limited in the embodiments of the present disclosure.

At Step S503, the water pump duty cycle of the water pump is adjusted to a ninth duty cycle when the system temperature is greater than the eighth temperature and less than or equal to the ninth temperature.

In some embodiments, the eighth temperature is 27° C. and the ninth temperature is 28° C. When the system temperature is greater than 27° C. and less than or equal to 28° C., the water pump duty cycle of the water pump is adjusted to 80%, that is, the ninth duty cycle is 80% correspondingly. Specifically, the self-circulation policy of the liquid-cooled unit is shown in Table 3 below, and the seventh duty cycle, the eighth duty cycle and the ninth duty cycle increase in sequence.

TABLE 3
Self-circulation Policy

| System Temperature | Water Pump Duty Cycle |
|---|---|
| 25° C. < T ≤ 26° C. | 20% |
| 26° C. < T ≤ 27° C. | 50% |
| 27° C. < T ≤ 28° C. | 80% |

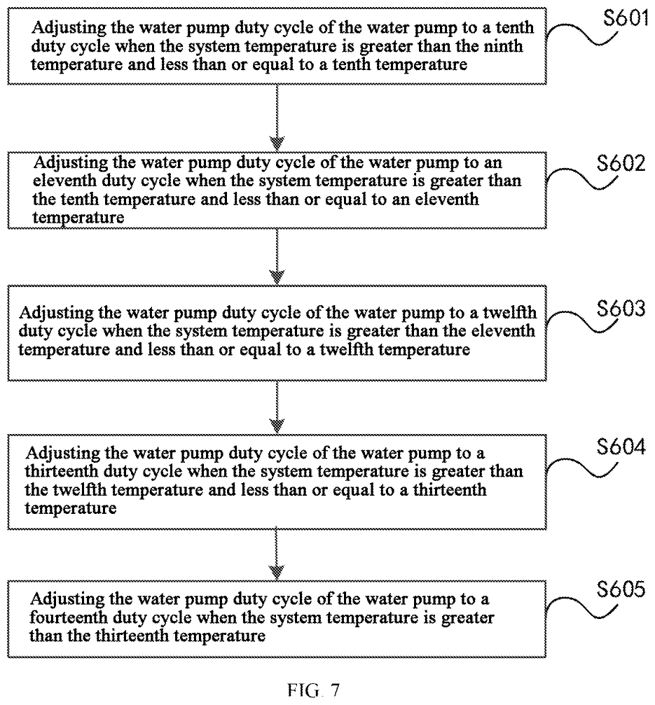

Referring to FIG. 7, in some embodiments of the present disclosure, Step S204 may further include, but is not limited to, Step S601 to Step S605 below.

At Step S601, the water pump duty cycle of the water pump is adjusted to a tenth duty cycle when the system temperature is greater than the ninth temperature and less than or equal to a tenth temperature.

In some embodiments, the third temperature threshold is the ninth temperature correspondingly, and the water pump duty cycle of the water pump is adjusted to the tenth duty cycle when the system temperature is greater than the ninth temperature and less than or equal to the tenth temperature. For example, the ninth temperature is 28° C. and the tenth temperature is 29° C. When the system temperature is greater than 28° C. and less than or equal to 29° C., the water pump duty cycle of the water pump is adjusted to 20%, that is, the tenth duty cycle is 20% correspondingly. It can be understood that those of ordinary skills in the art can set specific values for the ninth temperature, the tenth temperature and the tenth duty cycle according to actual requirements, which is not limited in the embodiments of the present disclosure.

At Step S602, the water pump duty cycle of the water pump is adjusted to an eleventh duty cycle when the system temperature is greater than the tenth temperature and less than or equal to an eleventh temperature.

In some embodiments, the tenth temperature is 29° C. and the eleventh temperature is 30° C. When the system temperature is greater than 29° C. and less than or equal to 30° C., the water pump duty cycle of the water pump is adjusted to 40%, that is, the eleventh duty cycle is 40% correspondingly. The eleventh temperature is higher than the tenth temperature, and correspondingly the eleventh duty cycle is greater than the tenth duty cycle, thus achieving more efficient cooling at higher temperature. It can be understood that those of ordinary skills in the art can set specific values for the tenth temperature, the eleventh temperature and the eleventh duty cycle according to actual requirements, which is not limited in the embodiments of the present disclosure.

At Step S603, the water pump duty cycle of the water pump is adjusted to a twelfth duty cycle when the system temperature is greater than the eleventh temperature and less than or equal to a twelfth temperature.

In some embodiments, the eleventh temperature is 30° C. and the twelfth temperature is 31° C. When the system temperature is greater than 30° C. and less than or equal to 31° C., the water pump duty cycle of the water pump is adjusted to 60%, that is, the twelfth duty cycle is 60% correspondingly. The twelfth temperature is higher than the eleventh temperature and the tenth temperature, and correspondingly the twelfth duty cycle is greater than the eleventh duty cycle and the tenth duty cycle, thus ensuring more efficient cooling at higher temperature.

At Step S604, the water pump duty cycle of the water pump is adjusted to a thirteenth duty cycle when the system temperature is greater than the twelfth temperature and less than or equal to a thirteenth temperature.

In some embodiments, the twelfth temperature is 31° C. and the thirteenth temperature is 32° C. When the system temperature is greater than 31° C. and less than or equal to 32° C., the water pump duty cycle of the water pump is adjusted to 80%, that is, the thirteenth duty cycle is 80% correspondingly. It can be understood that those of ordinary skills in the art can set specific values for the twelfth temperature, the thirteenth temperature and the thirteenth duty cycle according to actual requirements, which is not limited in the embodiments of the present disclosure.

At Step S605, the water pump duty cycle of the water pump is adjusted to a fourteenth duty cycle when the system temperature is greater than the thirteenth temperature.

In some embodiments, the thirteenth temperature is 32° C., and when the system temperature is greater than 32° C., the water pump duty cycle of the water pump is adjusted to 100%, that is, the thirteenth duty cycle is 100% correspondingly. Specifically, the cooling policy of the liquid-cooled unit is shown in Table 4 below, and the tenth duty cycle, the eleventh duty cycle, the twelfth duty cycle, the thirteenth duty cycle and the fourteenth duty cycle increase in sequence, thus achieving more efficient cooling at higher temperature.

TABLE 4
Cooling Policy

| | Water Pump Duty |
|---|---|
| System Temperature | Cycle |
| 28° C. < T ≤ 29° C. | 20% |
| 29° C. < T ≤ 30° C. | 40% |
| 30° C. < T ≤ 31° C. | 60% |
| 31° C. < T ≤ 32° C. | 80% |
| T > 32° C. | 100% |

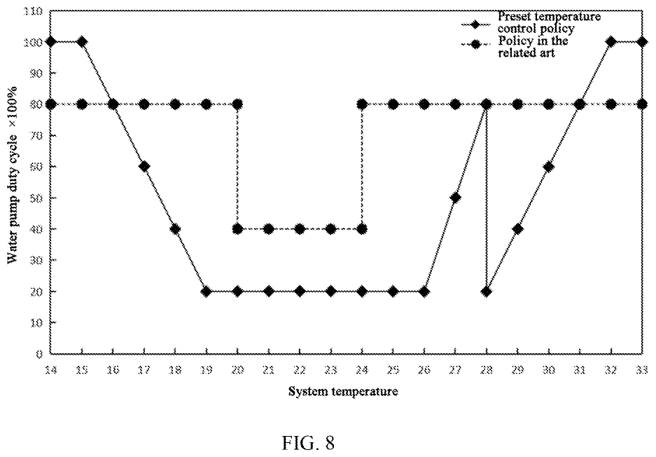

Referring to the variation curve of the water pump duty cycle shown in FIG. 8, in the embodiment of the present disclosure, different water pump duty cycles are formulated for different system temperatures. Compared with the conventional self-control solution for the policy in the related art, the self-power consumption of the liquid-cooled unit in the embodiments of the present disclosure can be reduced by more than 10% in the whole process of operation, and the water pump duty cycle can be adjusted in real time according to the cell temperatures, resulting in more precise temperature control and also being beneficial for increasing the cycle life of the whole unit.

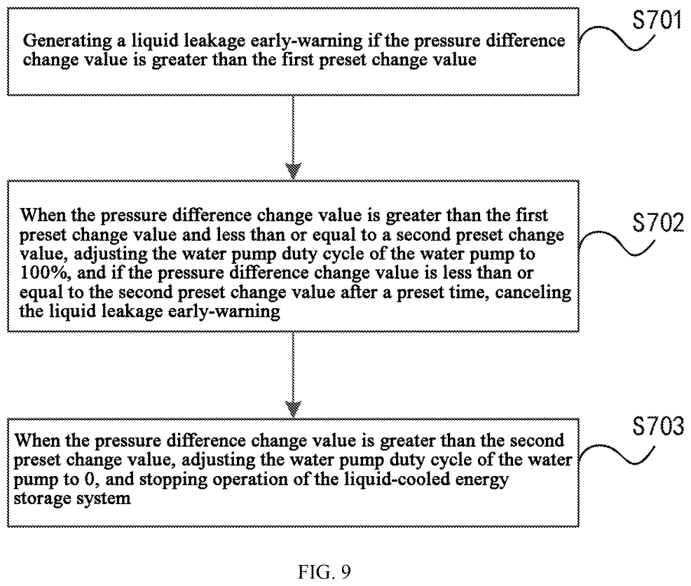

Referring to FIG. 9, in some embodiments of the present disclosure, Step S104 may further include, but is not limited to, Step S701 to Step S703 below.

At Step S701, a liquid leakage early-warning is generated if the pressure difference change value is greater than the first preset change value.

In some embodiments, if the pressure difference change value is greater than the first preset change value, then it is considered that the pressure difference is unstable and there is a risk of liquid leakage, so a liquid leakage early-warning is generated. Specifically, the first preset change value may be set according to actual conditions, e.g., 0.01 kPa. That is, if the difference between the difference between the water inlet pressure and the water outlet pressure in the current cycle and the difference between the water inlet pressure and the water outlet pressure in the previous cycle is greater than 0.01 kPa, then a liquid leakage early-warning is generated, which is not limited in the embodiments of the present disclosure.

At Step S702, when the pressure difference change value is greater than the first preset change value and less than or equal to a second preset change value, the water pump duty cycle of the water pump is adjusted to 100%, and if the pressure difference change value is less than or equal to the second preset change value after a preset time, the liquid leakage early-warning is canceled.

In some embodiments, when the pressure difference change value is greater than the first preset change value and less than or equal to the second preset change value, the water pump duty cycle of the water pump is adjusted to 100%. If the pressure difference change value is still less than or equal to the second preset change value after a preset time, then it is considered that the liquid-cooled energy storage system does no leak liquid, and the liquid leakage early-warning is canceled.

For example, the first preset change value is 0.01 kPa, the second preset change value is 1 kPa, and the preset time is 1 minute. Therefore, when the pressure difference change value meets 0.01 kPa<K≤1 kPa, the water pump duty cycle of the water pump is changed to 100%. If the pressure difference change value meets K≤1 kPa after 1 minute, then the liquid leakage early-warning is canceled. In some embodiments, the water pump duty cycle of the water pump may be controlled according to the current system temperature and the preset temperature control policy after the liquid leakage early-warning is canceled, which is not limited in the embodiments of the present disclosure.

At Step S703, when the pressure difference change value is greater than the second preset change value, the water pump duty cycle of the water pump is adjusted to 0, and the operation of the liquid-cooled energy storage system is stopped.

In some embodiments, if the pressure difference change value is greater than the second preset change value, then it is determined that the liquid-cooled energy storage system is leaking liquid, the water pump duty cycle of the water pump is adjusted to 0, and the operation of the liquid-cooled energy storage system is stopped. It can be understood that if the liquid leakage early-warning does not meet the condition for canceling the early-warning, the water pump duty cycle of the water pump may also be adjusted to 0, and the operation of the liquid-cooled energy storage system is stopped, which is not limited by the embodiments of the present disclosure.

Therefore, in the embodiments of the present disclosure, it is determined whether there exists the liquid leakage according to the change in the difference between the water inlet pressure and the water outlet pressure, and related measures are taken for potential liquid leakage risks. According to the difference between the water inlet pressure and the water outlet pressure, the pressure difference change value is calculated cyclically, and whether the system is leaking liquid and whether the system has a risk of liquid leakage are determined in real time according to the pressure difference change value, thus effectively increasing the reliability and safety of the liquid-cooled energy storage system.

The present disclosure will be illustrated with a complete embodiment below.

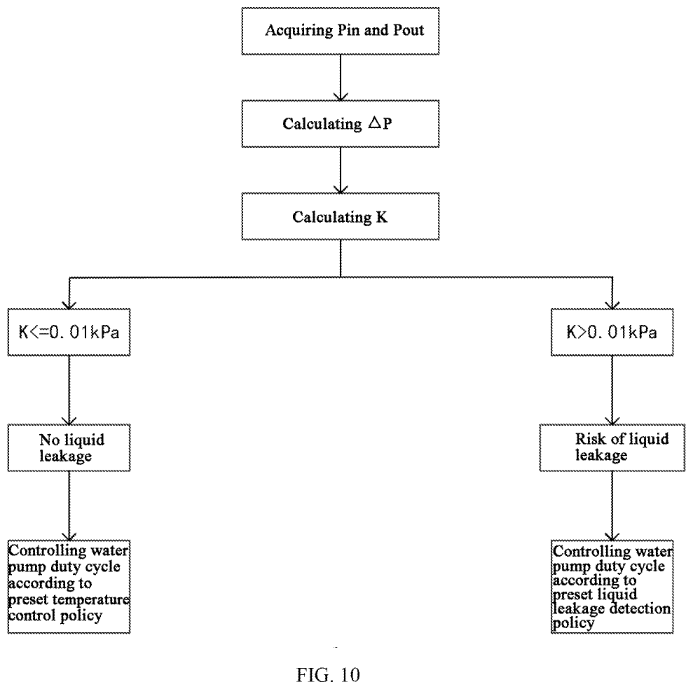

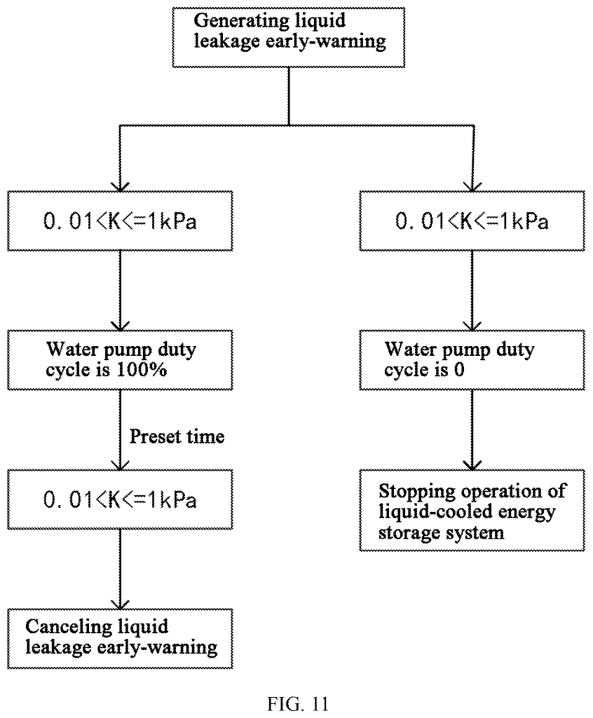

Referring to the flowchart of the method for controlling a liquid-cooled energy storage system shown in FIG. 10, after the liquid-cooled energy storage system is started for the first time and operates stably, for example, operates for half an hour, a water inlet pressure Pᵢₙ and a water outlet pressure Pₒᵤₜ of the liquid-cooled unit are obtained cyclically, and a difference between the water inlet pressure and the water outlet pressure ΔP in each cycle is calculated. A pressure difference change value K is obtained by calculation according to the difference between the water inlet pressure and the water outlet pressure in the current cycle and the difference between the water inlet pressure and the water outlet pressure in the previous cycle. A relationship between the pressure difference change value K and the first preset change value is determined to determine whether the system has a risk of liquid leakage. Different policies are then correspondingly taken to control the water pump duty cycle of the water pump. Specifically, if the pressure difference change value K is less than or equal to the first preset change value, then the water pump duty cycle of the water pump is controlled according to the system temperature and the preset temperature control policy, otherwise the water pump duty cycle of the water pump is controlled according to the preset liquid leakage detection policy.

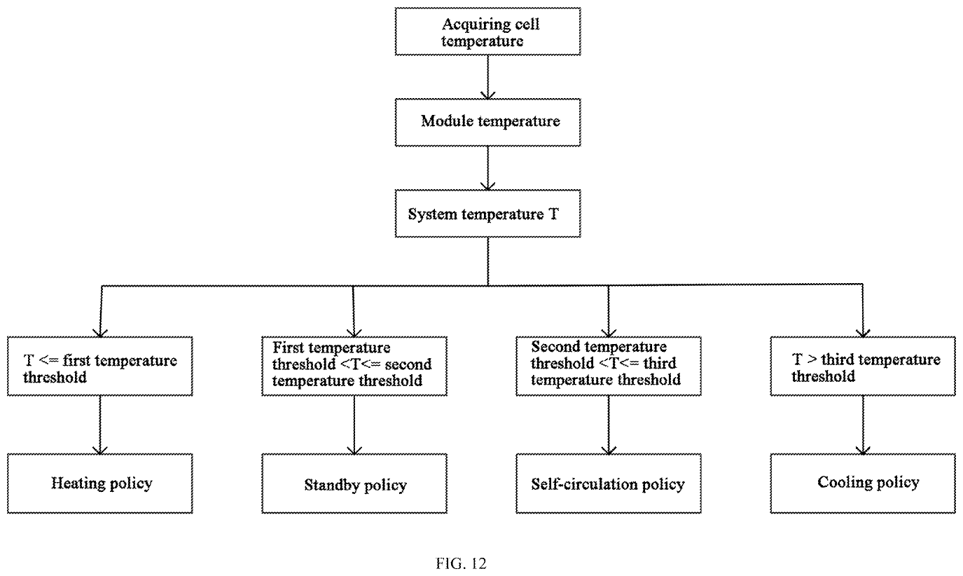

Specifically, referring to the flowchart of the preset liquid leakage detection policy shown in FIG. 11, if the pressure difference change value K is greater than the first preset change value, a liquid leakage early-warning is generated correspondingly. When the pressure difference change value K is greater than the first preset change value and less than or equal to a second preset change value, it is determined that the system may have a risk of liquid leakage. At this moment, the water pump duty cycle is adjusted to 100% and kept for a preset time, and the pressure difference change value K is then recalculated. If the pressure difference change value K is still less than or equal to the second preset change value, then it is determined that the system has no liquid leakage, and the liquid leakage early-warning is canceled. If the pressure difference change value K is greater than the second preset change value, then it is directly determined that the system has liquid leakage, the water pump duty cycle of the water pump is adjusted to 0, and the operation of the liquid-cooled energy storage system is stopped.

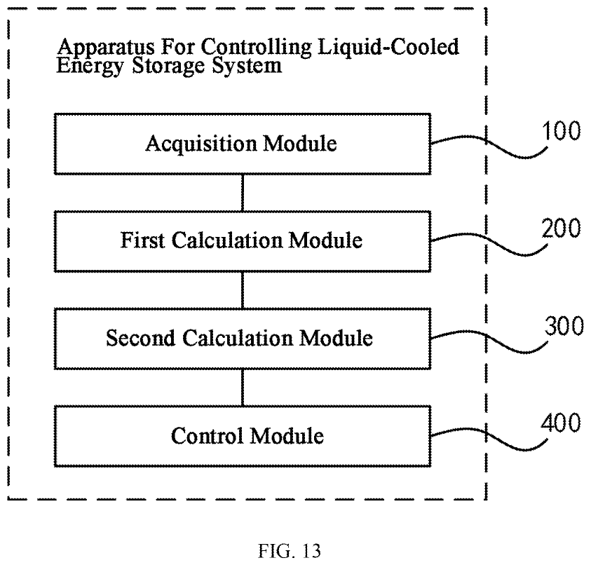

If the pressure difference change value K is less than the first preset change value, then it is determined that the system has no liquid leakage. At this moment, the water pump duty cycle of the water pump is adjusted according to the system temperature and the preset temperature control policy. Specifically, referring to the flowchart of the preset temperature control policy shown in FIG. 12, a cell temperature of each cell is acquired, and the maximum one of the cell temperatures is taken as a module temperature for each liquid-cooled battery module, and the maximum one of the module temperatures is then taken as a system temperature. By determining the relationship between the system temperature and the first temperature threshold, the second temperature threshold and the third temperature threshold, the water pump duty cycle of the water pump is controlled according to the heating policy, the standby policy, the self-circulation policy or the cooling policy.

Therefore, pipeline sealing integrity is monitored and calculated in real time by utilizing the difference between the water inlet pressure and the water outlet pressure of the liquid-cooled unit, and whether the system is leaking liquid and whether the system has a risk of liquid leakage is determined in real time according to the pressure difference change value, so that the water pump duty cycle is controlled according to the preset policy, thus increasing the reliability and safety of the liquid-cooled energy storage system, realizing the energy-saving and efficient operation of the liquid-cooled unit and reducing the auxiliary power consumption of the pipelines.

An embodiment of the present disclosure further provides an apparatus for controlling a liquid-cooled energy storage system, which can implement the aforementioned method for controlling a liquid-cooled energy storage system. Referring to FIG. 13, in some embodiments of the present disclosure, the apparatus for controlling a liquid-cooled energy storage system includes:
an acquisition module 100, configured to cyclically acquire a water inlet pressure and a water outlet pressure of a liquid-cooled unit;
a first calculation module 200, configured to obtain a difference between the water inlet pressure and the water outlet pressure in each cycle according to the acquired water inlet pressure and the acquired water outlet pressure;
a second calculation module 300, configured to perform calculation according to the difference between the water inlet pressure and the water outlet pressure in a current cycle and the difference between the water inlet pressure and the water outlet pressure in a previous cycle to obtain a pressure difference change value in the current cycle; and
a control module 400, configured to, in the current cycle, if the pressure difference change value meets a first preset change value, control a water pump duty cycle of a water pump according to a system temperature of the liquid-cooled energy storage system and a preset temperature control policy, otherwise control the water pump duty cycle of the water pump according to a preset liquid leakage detection policy.

The specific implementation of the apparatus for controlling a liquid-cooled energy storage system according to the embodiment of the present disclosure is substantially the same as the specific implementation of the aforementioned method for controlling a liquid-cooled energy storage system, which will not be repeated again herein.

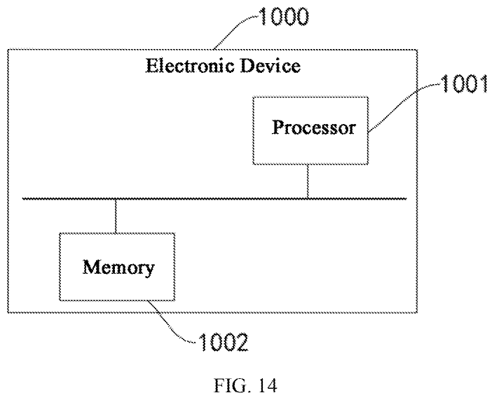

FIG. 14 shows an electronic device 1000 according to an embodiment of the present disclosure. The electronic device 1000 includes a processor 1001, a memory 1002 and a computer program stored in the memory 1002 and runnable in the processor 1001, wherein the computer program is configured to execute the aforementioned method for controlling a liquid-cooled energy storage system when running.

The processor 1001 and the memory 1002 may be connected through a bus or in other ways.

As a non-transitory computer-readable storage medium, the memory 1002 may be configured to store a non-transitory software program and a non-transitory computer-executable program, such as the method for controlling a liquid-cooled energy storage system described in the embodiments of the present disclosure. The processor 1001 implements the aforementioned method for controlling a liquid-cooled energy storage system by running the non-transient software program and instructions stored in the memory 1002.

The memory 1002 may include a program storage area and a data storage area. The storage program area may store an operating system and an application required by at least one function. The data storage area may store data for executing the aforementioned method for controlling a liquid-cooled energy storage system. In addition, the memory 1002 may include a high-speed random-access memory 1002, and may also include a non-transitory memory 1002, e.g., at least one storage device, flash memory device or other non-transitory solid-state memory devices. In some embodiments, the memory 1002 optionally includes memories 1002 disposed remotely relative to the processor 1001, and these remote memories 1002 may be connected to the electronic device 1000 through a network. Examples of the above network include, but not limited to, the Internet, an intranet, a local area network, a mobile communication network, and combinations thereof.

The non-transient software program and instructions required to implement the aforementioned method for controlling a liquid-cooled energy storage system are stored in the memory 1002 which, when executed by one or more processors 1001, cause the one or more processors 1001 to perform the aforementioned method for controlling a liquid-cooled energy storage system, e.g. perform Step S101 to Step S104 in FIG. 1, Step S201 to Step S204 in FIG. 2, Step S301 to Step S303 in FIG. 4, Step S401 to Step S405 in FIG. 5, Step S501 to Step S503 in FIG. 6, Step S601 to Step S605 in FIG. 7 and Step S701 to Step S703 in FIG. 9.

An embodiment of the present disclosure further provides a storage medium, which is a computer-readable storage medium. The storage medium stores a computer program which, when executed by a processor, causes the processor to implement the aforementioned method for controlling a liquid-cooled energy storage system. As a non-transitory computer-readable storage medium, the memory may be configured to store a non-transitory software program and a non-transitory computer-executable program. In addition, the memory may include a high-speed random-access memory, and may also include a non-transitory memory, e.g., at least one disk storage device, flash memory device or other non-transitory solid-state memory devices. In some embodiments, the memory optionally includes memories disposed remotely relative to the processor, and these remote memories may be connected to the processor through a network. Examples of the above network include, but not limited to, the Internet, an intranet, a local area network, a mobile communication network, and combinations thereof.

According to the method and apparatus for controlling a liquid-cooled energy storage system, the electronic device and the storage medium provided by the embodiments of the present disclosure, a water inlet pressure and a water outlet pressure of the liquid-cooled unit are acquired cyclically, and a corresponding difference between the water inlet pressure and the water outlet pressure in each cycle is obtained according to the acquired water inlet pressure and the acquired water outlet pressure. Calculation is performed according to the difference between the water inlet pressure and the water outlet pressure in the current cycle and the difference between the water inlet pressure and the water outlet pressure in the previous cycle to obtain a pressure difference change value in the current cycle, and if the pressure difference change value is less than or equal to a first preset change value, a water pump duty cycle of a water pump is controlled according to a system temperature of the liquid-cooled energy storage system and a preset temperature control policy, otherwise the water pump duty cycle of the water pump is controlled according to a preset liquid leakage detection policy. Therefore, the pressure difference change value is monitored and calculated in real time by utilizing the difference between the water inlet pressure and the water outlet pressure of the liquid-cooled unit, and the different preset policies are chosen to control the water pump duty cycle according to the pressure difference change value. If the pressure difference change value is less than or equal to the first preset change value, it is determined that the sealing integrity of the system is good at this moment, so the energy saving of the system is emphasized. A too high water pump duty cycle will increase the power consumption and temperature of the pump, while a too low water pump duty cycle will decrease the cooling effect, leading to an increase in the system temperature. Therefore, considering the influence of temperature, a reasonable duty cycle is generated according to the preset temperature control policy in order to meet the requirement of energy saving and increase the reliability of the system. In addition, if the pressure difference change value is greater than the first preset change value, it means that the system is unstable at this moment, and there may be a risk of liquid leakage. At this moment, the sealing integrity of the system is at high priority. Therefore, it is necessary to control the water pump duty cycle for liquid leakage detection according to the preset liquid leakage detection policy to strike a balance between the pressure and sealing integrity of the system, so as to ensure the normal operation of the system, accurately detect in time whether liquid leakage occurs, and increase the reliability of the system.

The embodiments described above are merely schematic in which the units illustrated as separate components may or may not be physically separated, that is, the units may be located in one place or distributed on a plurality of network units. Some or all of the modules may be selected according to actual needs to achieve the objective of the solution of the embodiments of the present disclosure.

It can be understood by those of ordinary skill in the art that all or some of the steps in the method and the system disclosed above can be implemented as software, firmware, hardware and an appropriate combination thereof. Some or all of the physical components may be implemented as software executed by a processor (such as a central processing unit, a digital signal processor a microprocessor), hardware or an integrated circuit (such as an application-specific integrated circuit). Such software may be distributed on computer-readable media, which may include computer storage media (or non-transitory media) and communication media (or transitory media). As is well-known to those of ordinary skill in the art, the term “computer storage medium” includes volatile and nonvolatile, removable and non-removable medium implemented in any method or technology for storing information (such as computer-readable instructions, data structures, program modules or other data). Computer storage medium includes but is not limited to RAM, ROM, EEPROM, flash memory or other memory technologies, CD-ROM, digital versatile disk (DVD) or other optical disk storage, magnetic cassettes, magnetic tapes, storage or other magnetic storage devices or any other medium that can be used to store desired information and can be accessed by a computer. Furthermore, it is well-known to those of ordinary skill in the art that the communication medium typically contains computer-readable instructions, data structures, program modules or other data in a modulated data signal such as carriers or other transmission mechanisms, and can include any information delivery medium.

It should also be understood that various implementations provided by the embodiments of the present disclosure may be arbitrarily combined to achieve different technical effects. Preferred embodiments of the present disclosure have been described in detail above. However, the present disclosure is not limited to the aforementioned embodiments. Those of ordinary skills in the art can also make various equivalent modifications or replacements without violating the shared conditions of the spirit of the present disclosure.

What is claimed is:

1. A method for controlling a liquid-cooled energy storage system comprising a liquid-cooled unit and a water pump, the method comprising:
cyclically acquiring a water inlet pressure and a water outlet pressure of the liquid-cooled unit;
obtaining a difference between the water inlet pressure and the water outlet pressure in each cycle according to the acquired water inlet pressure and the acquired water outlet pressure;
performing calculation according to the difference between the water inlet pressure and the water outlet pressure in a current cycle and the difference between the water inlet pressure and the water outlet pressure in a previous cycle to obtain a pressure difference change value in the current cycle; and
in the current cycle, if the pressure difference change value is less than or equal to a first preset change value, controlling a water pump duty cycle of the water pump according to a system temperature of the liquid-cooled energy storage system and a preset temperature control policy; otherwise controlling the water pump duty cycle of the water pump according to a preset liquid leakage detection policy.

2. The method for controlling a liquid-cooled energy storage system according to claim 1, wherein the preset temperature control policy comprises a heating policy, a standby policy, a self-circulation policy, and a cooling policy; and the controlling a water pump duty cycle of the water pump according to a system temperature of the liquid-cooled energy storage system and a preset temperature control policy comprises:
controlling the liquid-cooled unit to adjust the water pump duty cycle of the water pump according to the heating policy if the system temperature is less than or equal to a first temperature threshold;
controlling the liquid-cooled unit to adjust the water pump duty cycle of the water pump according to the standby policy if the system temperature is greater than the first temperature threshold and less than or equal to a second temperature threshold;
controlling the liquid-cooled unit to adjust the water pump duty cycle of the water pump according to the self-circulation policy if the system temperature is greater than the second temperature threshold and less than or equal to a third temperature threshold; and
controlling the liquid-cooled unit to adjust the water pump duty cycle of the water pump according to the cooling policy if the system temperature is greater than the third temperature threshold.

3. The method for controlling a liquid-cooled energy storage system according to claim 1, wherein the liquid-cooled energy storage system further comprises a plurality of liquid-cooled battery modules, wherein each of the liquid-cooled battery modules comprises a plurality of cells; and before the controlling a water pump duty cycle of the water pump according to a system temperature of the liquid-cooled energy storage system and a preset temperature control policy, the method further comprises:
acquiring a cell temperature of each of the cells;
for each of the liquid-cooled battery modules, taking a maximum one of the cell temperatures as a module temperature; and
taking a maximum one of the module temperatures as a system temperature.

4. The method for controlling a liquid-cooled energy storage system according to claim 2, wherein the first temperature threshold is a first temperature, and the controlling the liquid-cooled unit to adjust the water pump duty cycle of the water pump according to the heating policy if the system temperature is less than or equal to a first temperature threshold comprises:
adjusting the water pump duty cycle of the water pump to a first duty cycle when the system temperature is greater than a second temperature and less than or equal to the first temperature;
adjusting the water pump duty cycle of the water pump to a second duty cycle when the system temperature is greater than a third temperature and less than or equal to the second temperature;
adjusting the water pump duty cycle of the water pump to a third duty cycle when the system temperature is greater than a fourth temperature and less than or equal to the third temperature;
adjusting the water pump duty cycle of the water pump to a fourth duty cycle when the system temperature is greater than a fifth temperature and less than or equal to the fourth temperature; and
adjusting the water pump duty cycle of the water pump to a fifth duty cycle when the system temperature is less than or equal to the fifth temperature;
wherein the first duty cycle, the second duty cycle, the third duty cycle, the fourth duty cycle and the fifth duty cycle increase in sequence.

5. The method for controlling a liquid-cooled energy storage system according to claim 2, wherein the first temperature threshold is a first temperature, and the second temperature threshold is a sixth temperature; and the controlling the liquid-cooled unit to adjust the water pump duty cycle of the water pump according to the standby policy if the system temperature is greater than the first temperature threshold and less than or equal to a second temperature threshold comprises:
when the system temperature is greater than the first temperature and less than or equal to the sixth temperature, controlling the liquid-cooled unit to enter a standby mode, and keeping the water pump duty cycle of the water pump at a sixth duty cycle.

6. The method for controlling a liquid-cooled energy storage system according to claim 2, wherein the second temperature threshold is a sixth temperature, and the third temperature threshold is a ninth temperature; and the controlling the liquid-cooled unit to adjust the water pump duty cycle of the water pump according to the self-circulation policy if the system temperature is greater than the second temperature threshold and less than or equal to a third temperature threshold comprises:
adjusting the water pump duty cycle of the water pump to a seventh duty cycle when the system temperature is greater than the sixth temperature and less than or equal to a seventh temperature;
adjusting the water pump duty cycle of the water pump to an eighth duty cycle when the system temperature is greater than the seventh temperature and less than or equal to an eighth temperature; and
adjusting the water pump duty cycle of the water pump to a ninth duty cycle when the system temperature is greater than the eighth temperature and less than or equal to the ninth temperature;
wherein the seventh duty cycle, the eighth duty cycle and the ninth duty cycle increase in sequence.

7. The method for controlling a liquid-cooled energy storage system according to claim 2, wherein the third temperature threshold is a ninth temperature; and the controlling the liquid-cooled unit to adjust the water pump duty cycle of the water pump according to the cooling policy if the system temperature is greater than the third temperature threshold comprises:
adjusting the water pump duty cycle of the water pump to a tenth duty cycle when the system temperature is greater than the ninth temperature and less than or equal to a tenth temperature;
adjusting the water pump duty cycle of the water pump to an eleventh duty cycle when the system temperature is greater than the tenth temperature and less than or equal to an eleventh temperature;
adjusting the water pump duty cycle of the water pump to a twelfth duty cycle when the system temperature is greater than the eleventh temperature and less than or equal to a twelfth temperature;
adjusting the water pump duty cycle of the water pump to a thirteenth duty cycle when the system temperature is greater than the twelfth temperature and less than or equal to a thirteenth temperature; and
adjusting the water pump duty cycle of the water pump to a fourteenth duty cycle when the system temperature is greater than the thirteenth temperature;
wherein the tenth duty cycle, the eleventh duty cycle, the twelfth duty cycle, the thirteenth duty cycle and the fourteenth duty cycle increase in sequence.

8. The method for controlling a liquid-cooled energy storage system according to claim 1, wherein the controlling the water pump duty cycle of the water pump according to a preset liquid leakage detection policy comprises:
generating a liquid leakage early-warning if the pressure difference change value is greater than the first preset change value;
when the pressure difference change value is greater than the first preset change value and less than or equal to a second preset change value, adjusting the water pump duty cycle of the water pump to 100%, and if the pressure difference change value is less than or equal to the second preset change value after a preset time, canceling the liquid leakage early-warning; and
when the pressure difference change value is greater than the second preset change value, adjusting the water pump duty cycle of the water pump to 0, and stopping operation of the liquid-cooled energy storage system.

9. An apparatus for controlling a liquid-cooled energy storage system, applying the method for controlling a liquid-cooled energy storage system according to claim 1, comprising:
an acquisition module, configured to cyclically acquire a water inlet pressure and a water outlet pressure of the liquid-cooled unit;
a first calculation module, configured to obtain a difference between the water inlet pressure and the water outlet pressure in each cycle according to the acquired water inlet pressure and the acquired water outlet pressure;
a second calculation module, configured to perform calculation according to the difference between the water inlet pressure and the water outlet pressure in a current cycle and the difference between the water inlet pressure and the water outlet pressure in a previous cycle to obtain a pressure difference change value in the current cycle; and
a control module, configured to, in the current cycle, if the pressure difference change value meets a first preset change value, control a water pump duty cycle of the water pump according to a system temperature of the liquid-cooled energy storage system and a preset temperature control policy; otherwise control the water pump duty cycle of the water pump according to a preset liquid leakage detection policy.

10. An electronic device, comprising: a memory and a processor, wherein the memory stores a computer program, and the processor, when executing the computer program, implements the method for controlling a liquid-cooled energy storage system according to claim 1.

11. A non-transitory computer-readable storage medium storing a program, wherein the program, when executed by a processor, causes the processor to implement the method for controlling a liquid-cooled energy storage system according to claim 1.
